(19) United States
(12) Patent Application Publication
(10) Pub. No.: US 2013/0104728 A1
(43) Pub. Date: May 2, 2013

(54) BOOSTER ASSEMBLY FOR VEHICLE

(71) Applicant: MANDO CORPORATION, Gyeonggi-do (KR)

(72) Inventors: Chang Bok KO, Gyunggi-do (KR); Young Jun SON, Gyeonggi-do (KR)

(73) Assignee: MANDO CORPORATION, Gyeonggi-do (KR)

(21) Appl. No.: 13/667,544

(22) Filed: Nov. 2, 2012

(30) Foreign Application Priority Data
Nov. 2, 2011 (KR) 10-2011-0113093

(51) Int. Cl. F15B 9/10

(52) U.S. Cl. 91/376 R

(57) ABSTRACT

A booster assembly for a vehicle capable of reducing the noise and manufacturing cost thereof, the booster assembly including an input rod configured to reciprocate in linkage with a brake pedal, a control plunger configured to reciprocate in linkage with the input rod, and a boosting piston configured to reciprocate in linkage with the control plunger or reciprocate in linkage with a valve body, wherein the boosting piston directly transmits an output, which is generated at the booster, to the master cylinder without being separated.

### CROSS-REFERENCE TO RELATED APPLICATION

This application claims the benefit of Korean Patent Application No. 2011-0113093, filed on Nov. 2, 2011 in the Korean Intellectual Property Office, the disclosure of which is incorporated herein by reference.

### BACKGROUND

1. Field

Embodiments of the present disclosure relate to a booster assembly for a vehicle, and more particularly, to a booster assembly for a vehicle capable of reducing noise and the manufacturing cost thereof.

2. Description of the Related Art

In general, a booster assembly for a vehicle is an apparatus designed to generate a hydraulic pressure with a small force by use of the difference in pressure between vacuum and the atmosphere, and as shown in FIG. 1, includes a booster configured to generate a great force with a small force, and a master cylinder to convert the generated force into a hydraulic pressure.

The booster is provided at an inside thereof with a cell 1 partitioned into a constant pressure chamber 2 and a variant pressure compartment 3. In addition, the booster is further provided with a valve unit 5 so as to have the pressure of the constant pressure chamber 2 be equal to the pressure of the variant pressure chamber 3 by communicating the constant pressure chamber 2 with the variant pressure chamber 3 according to the operation of an input rod 4, or so as to produce a difference in pressure between the constant pressure chamber 2 and the variant pressure chamber 3 by blocking the communication between the constant pressure chamber 2 and the variant pressure chamber 3 while allowing the variant pressure chamber 3 to be communicated with the atmosphere according to the operation of the input rod 4. A suction pressure of an engine of the vehicle acts on the constant pressure chamber 2.

In the case of such a convention booster, when the input rod 4 moves forward in linkage with a control plunger 9 by a brake pedal pressed, the constant pressure chamber 2 is blocked from the variant pressure chamber 3 while allowing the variant pressure chamber 3 to be communicated with the atmosphere, thereby producing a difference in pressure between the constant pressure chamber 2 and the variant pressure chamber 3. The difference in pressure moves a power piston 6 and the valve unit 5, which are configured to partition the constant pressure chamber 2 from the variant pressure chamber 3, toward an output rod 7 to press the output rod 7, thereby producing an output having amplification of the input. The output is transmitted to the master cylinder to generate a braking force.

The master cylinder includes a cylinder body 11, and a first piston 13 and a second piston 15 that are reciprocatingly installed at an inside a bore 12 of the cylinder body 11. Each of the first piston 13 and the second piston 14 is provided with a plurality of passages allowing oil to be introduced toward a first fluid pressure chamber 17 and a second fluid pressure chamber 18 through an oil port 16 communicated with an oil tank 15.

In the case of the conventional master cylinder, if the first piston 13 and the second piston 14 move forward by a hydraulic pressure formed in the booster, the oil port and the plurality of passages are blocked by a sealing member, and the fluid pressures of the first and second fluid pressure chambers 17 and 18 are increased.

On the contrary, if the first piston 17 and the second piston 18 move backward, oil of the first and second fluid pressure chambers 17 and 18 returns to the oil tank and the fluid pressures at an inside the first and second fluid pressure chambers 17 and 18 are lowered, so that the braking pressure is removed.

Meanwhile, as for a conventional booster assembly for a vehicle, the output rod 7 moves back and forth in linkage with the first piston 13. The output rod 7 and the first piston 13 move back and forth while being spaced apart from each other. In this case, a noise due to the interval between the output rod 7 and the first piston 13 may occur. In addition, the conventional boost assembly for the vehicle is not incorporated with the first piston 13, thereby having a limitation in transmitting the boosting force of the booster to the output rod 7 without energy loss.

### SUMMARY

Therefore, it is an aspect of the present disclosure to provide a boost assembly for a vehicle capable of reducing noise occurring in a booster.

It is another aspect of the present disclosure to provide a booster assembly for a vehicle capable of reducing the manufacturing cost of a booster.

It is another aspect of the present disclosure to provide a booster assembly for a vehicle capable of reducing a power loss occurring in a booster.

Additional aspects of the disclosure will be set forth in part in the description which follows and, in part, will be obvious from the description, or may be learned by practice of the disclosure.

In accordance with one aspect of the present disclosure, a booster assembly for a vehicle provided with a booster and a master cylinder, the booster assembly includes an input rod, a control plunger and a boosting piston. The input rod may be configured to reciprocate in linkage with a brake pedal. The control plunger may be configured to reciprocate in linkage with the input rod. The boosting piston may be configured to reciprocate in linkage with the control plunger or reciprocate in linkage with a valve body. The boosting piston directly transmits an output, which is generated at the booster, to the master cylinder without being separated.

A reaction disc may be installed between the control plunger and the boosting piston, and the boosting piston performs a boosting in accordance with a boosting operation of the control plunger and the reaction disc.

The boosting piston is provided at an outer circumferential surface thereof with a boosting force coupling part that is configured to make contact with the reaction disc.

As described above, a booster assembly in accordance with the present disclosure has an output rod integrated with a first piston, thereby preventing noise from being generated due to a gap between the output rod and the first piston.

In addition, a booster assembly in accordance with the present disclosure is provided with a boosting piston by integrally forming an output rod with a first piston, thereby reducing the manufacturing cost thereof.

In addition, a booster assembly in accordance with the present disclosure has an output rod integrated with a first piston, thereby reducing a power loss occurring at the output rod and the first piston.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross sectional view illustrating a conventional booster assembly for a vehicle.

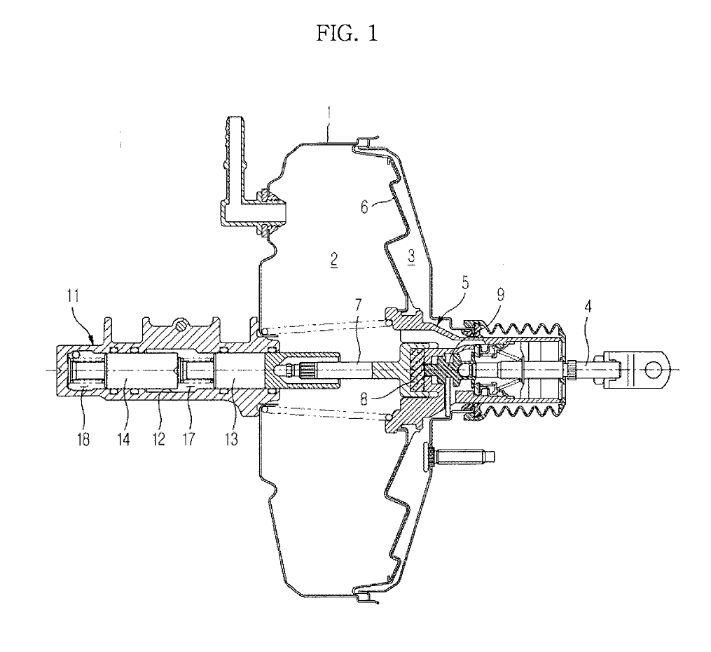

FIG. 2 is a cross sectional view illustrating a mounting state of a booster assembly for a vehicle in accordance with one embodiment of the preset disclosure.

FIG. 3 is an enlarged view illustrating a principle portion of a booster assembly for the vehicle in accordance with one embodiment of the preset disclosure.

### DETAILED DESCRIPTION

Reference will now be made in detail to the embodiments of the present disclosure, examples of which are illustrated in the accompanying drawings, wherein like reference numerals refer to like elements throughout.

A booster assembly for a vehicle in accordance with one embodiment of the present disclosure includes a booster configured to generate a great force with a small force, and a master cylinder configured to convert the force generated at the booster into a hydraulic pressure.

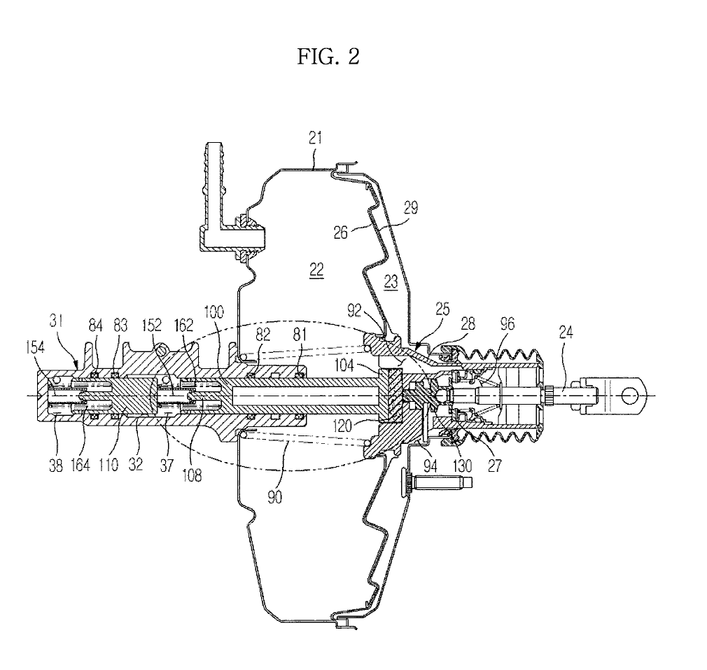

Referring to FIG. 2, the booster assembly further includes an input rod 24 to reciprocate in linkage with a brake pedal, a control plunger 130 to reciprocate in linkage with the input rod 24, a boosting piston 100 to reciprocate in linkage with the control plunger 130 or reciprocate in linkage with a valve body 28, and a subsidiary piston 110 to reciprocate in linkage with the boosting piston 100.

The booster, as shown in FIG. 2, is provided at an inside thereof with a cell 21 partitioned into a constant pressure chamber 22 and a variant pressure chamber 23. In addition, the booster is further provided with a valve unit 25 so as to have the pressure of the constant pressure chamber 22 be equal to the pressure of the variant pressure chamber 23 by communicating the constant pressure chamber 22 with the variant pressure chamber 23 according to the operation of the input rod 24, or so as to produce a difference in pressure between the constant pressure chamber 22 and the variant pressure chamber 23 by blocking the communication between the constant pressure chamber 22 and the variant pressure chamber 23 while allowing the variant pressure chamber 23 to be communicated with the atmosphere according to the operation of the input rod 24.

The cell 21 is partitioned into the constant pressure chamber 22 and the variant pressure chamber 23 that are provided at a front and a rear of the interior space of the cell 21, respectively. As shown in FIG. 2, the cell 21 is provided at an inside thereof with a power piston 29 and a diaphragm 26. A negative pressure connection pipe connected to a negative pressure source, for example, an intake manifold of the vehicle, is installed at a front surface of the cell 21 to maintain the constant pressure chamber 22 at an atmosphere pressure or below.

The valve unit 25 is installed at a rear end of the cell 21 described above to adjust the pressures of the constant pressure chamber 22 and the variant pressure chamber 23. As shown in FIG. 2, the valve unit 25 includes the valve body 28 having a hollowness 96, and a poppet valve 27 installed at an inside the valve body 28 to open and close a passage according to the operation of the input rod 24 that is to be described later.

The valve body 28 is installed so as to enable reciprocation at a rear end of the cell 21. As shown in FIG. 2, the valve body 28 is installed to have an outer surface of a front end portion thereof admitted to the inside the cell 21 such that the power piston 29 and the diaphragm 26 are fixed to the valve body 28. The power piston 29 moves back and forth together with the valve body 28 by a difference in pressure between the constant pressure chamber 22 and the variant pressure chamber 23. Accordingly, the valve body 28 moves back and forth together with the power piston 29 by a difference in pressure between the constant pressure chamber 22 and the variant pressure chamber 23 when the power piston 29 moves back and forth.

The valve body 28 is provided at an inside thereof with a constant pressure passage 92 to communicate the constant pressure chamber 22 with the variant pressure chamber 23, and with a variant pressure passage 94 to communicate the variant pressure chamber 23 with the atmosphere. As shown in FIG. 2, the constant pressure passage 92 is provided in a longitudinal direction of an upper portion of the hollowness 96 so as to communicate with the constant pressure chamber 22, and the variant pressure passage 94 is provided in a radial direction of a lower portion of the hollowness 96 so as to communicate with the variant pressure chamber 23.

The poppet valve 27 is installed at an inner circumferential surface of the valve body 28 to selectively open and close the constant pressure passage 92 and the variant pressure passage 94 according to the reciprocating motion of the input rod 24. As shown in FIG. 2, the poppet valve 27 is fixed to an inner surface of the valve body 28 at an outer side of the input rod 24, and provided in the form of a flexible pipe so as to enable a compression-expansion. A restoration spring 90 is installed at an inside the cell 21 to provide the valve body 28 with a restoration force.

The master cylinder, as shown in FIG. 2, includes a cylinder body 31 having a bore 32, an oil tank coupled to an upper end of the master cylinder while being coupled to the cylinder body 31, sealing members 81, 82, 83 and 84 to seal the inside of the cylinder body 31 and the outsides of the boosting piston 100 and the subsidiary piston 110, and the boosting piston 100 and the subsidiary piston 110 reciprocatingly installed at the inside of the bore 32 of the cylinder body 31.

At an inside the cylinder body 31, a first fluid pressure chamber 37 is formed between the boosting piston 100 and the subsidiary piston 110, and a second fluid pressure chamber 38 is formed between the subsidiary piston 110 and an inner surface of an end portion of the bore 32.

Oil ports connected to the oil tank are provided at an upper portion of the cylinder body 31, and the oil ports are communicated with the first fluid pressure chamber 37 and the second fluid pressure chamber 38.

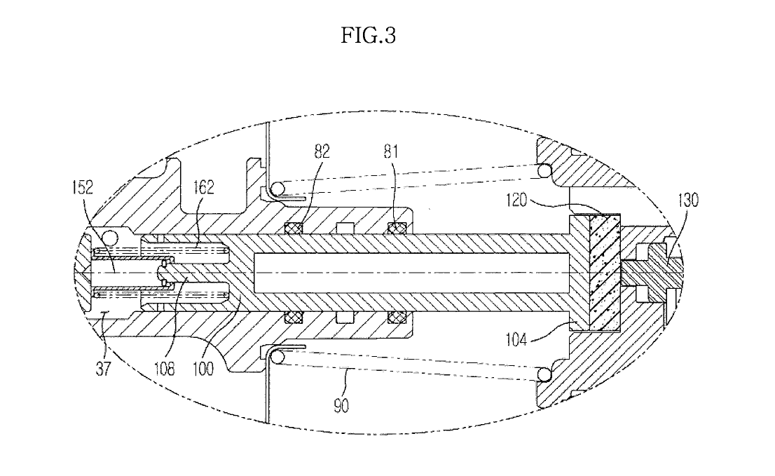

Meanwhile, the booster assembly for the vehicle in accordance with one of the present disclosure is provided with the boosting piston 100 having the output rod 7 of the conventional booster coupled to the first piston 13 of the conventional master cylinder. In addition, as shown in FIGS. 2 and 3, the subsidiary piston 110 is provided at one side of the boosting piston 100 to generate a braking fluid pressure in linkage with the booting piston 100.

The boosting piston 100 moves back and forth in linkage with the control plunger 130 or the valve body 28 to directly transmit the power generated from the booster to the master cylinder. As shown in FIGS. 2 and 3, the boosting piston 100 is installed at an inside the bore 32 and at an inside the cell 21 to generate the braking fluid pressure at the first fluid pressure chamber 37. The boosting piston 100 is configured to directly transmit the power boosted at the booster to the master cylinder.

A rear end of the boosting piston 100 is coupled to the valve body 28 while interposing a reaction disc 120 that may conduct elastic deformation. As shown in FIG. 2, for the coupling as such, a boosting force coupling part 104 is provided at the rear end of the boosting piston 100, and the reaction disc 120 is accommodated in the boosting force coupling part 104.

As shown in FIGS. 2 and 3, the boosting piston 100 is provided at one side thereof with a groove to accommodate a first spring 162 to provide the boosting piston 100 with a restoring force. A supporting part 108 protrudes from the groove such that a first retainer 152 is installed on the supporting part 108.

The subsidiary piston 110 is configured to generate a braking fluid pressure in linkage with the boosting piston 100. As shown in FIGS. 2 and 3, the subsidiary piston 110 is provided at one side thereof with a groove to accommodate a second spring 164 to provide the subsidiary piston 110 with a restoring force. A supporting part 108 protrudes from the groove such that a second retainer 154 is installed on the supporting part 108.

The boosting piston 100 is connected to the subsidiary piston 110 in series while being spaced apart from each other. As shown in FIGS. 2 and 3, the boosting piston 100 and the subsidiary piston 110 move back and forth at the inside the bore 32 of the cylinder body 31. Accordingly, upon braking, the boosting piston 100 and the subsidiary piston 110 move forward at the inside the bore 32 of the cylinder body 31 to increase the pressures of the first fluid pressure chamber 37 and the second fluid pressure chamber 38 to form the braking fluid pressure. For the miniaturization of the electronic parts, the boosting piston 100 may be integrally formed with the subsidiary piston 110.

The boosting piston 100, as shown in FIGS. 2 and 3, performs boosting by a boosting operation of the reaction disc 120 and the control plunger 130. Such a booting operation is caused by the difference in an area between the control plunger 130 and the reaction disc 120.

The reaction disc 120 formed of elastic material is installed between the boosting force coupling part 104 of the boosting piston 100 and the control plunger 130. A predetermined gap space is formed between the boosting force coupling part 104 of the boosting piston 100 and the control plunger 130. The predetermined gap space makes a closed space, and has Pascal's principle applied thereto. While the boosting piston 100 is filling in the predetermined gap space, a perfect inelastic movement performing a relative movement in accordance with the contact of the boosting piston 100, the reaction disc 120 and the control plunger 130 does not occur, so that the reaction force of the boosting piston 100 is transmitted to the control plunger 130. In this case, a Jump-in effect occurs in which a braking force is rapidly increased without receiving increased input. Meanwhile, if a relative movement in accordance with the contact of the boosting piston 100, the reaction disc 120 and the control plunger 130 is performed, the reaction force of the control plunger 130 is transmitted to the boosting piston 100, thereby producing an output in proportion to an input.

Hereinafter, an operation of the booster assembly for the vehicle in accordance with the present disclosure and effects thereof will be described.

As for the booster assembly of the vehicle, as shown in FIGS. 2 and 3, upon braking, the brake pedal is pressed, and the constant pressure chamber 22 is blocked from the variant pressure chamber 23 and the variant pressure chamber 23 is communicated with the atmosphere, thereby producing a difference in pressure between the constant pressure chamber 22 and the variant pressure chamber 23. The difference in pressure causes the power piston 29 and the valve body 28, which are configured to partition the constant pressure chamber 22 from the variant pressure chamber 23, toward the boosting piston 100 to press the boosting piston 100, thereby producing an output greater than an input. The output is transmitted to the master cylinder.

As for the master cylinder, the boosting piston 100 and the subsidiary piston 110 move forward by the hydraulic pressure formed at the booster, and the fluid pressures of the first and second fluidic pressure chamber 37 and 38 at an inside the master cylinder are increased. The increase of the fluid pressures as such generates a braking fluid pressure, and the braking fluid pressure is transmitted to a wheel cylinder, thereby generating a braking force.

As described above, the booster assembly for the vehicle in accordance with the present disclosure can remove noise that may occur from a gap between the output rod 7 and the first piston 13 by including the booting piston 100 having the output rod 7 integrated with the first piston 13.

In addition, the booster assembly for the vehicle in accordance with the present disclosure can reduce the manufacturing cost thereof by including the boosting piston 100 having the output rod 7 integrated with the first piston 13.

In addition, the booster assembly for the vehicle in accordance with the present disclosure can reduce a power loss occurring in the output rod 7 and the first piston 13 by having the output rod 7 integrated with the first piston 13.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A booster assembly for a vehicle provided with a booster and a master cylinder, the booster assembly comprising:
an input rod configured to reciprocate in linkage with a brake pedal;
a control plunger configured to reciprocate in linkage with the input rod; and
a boosting piston configured to reciprocate in linkage with the control plunger or reciprocate in linkage with a valve body,
wherein the boosting piston directly transmits an output, which is generated at the booster, to the master cylinder without being separated.

2. The booster assembly of claim 1, wherein a reaction disc is installed between the control plunger and the boosting piston, and the boosting piston performs a boosting in accordance with a boosting operation of the control plunger and the reaction disc.

3. The booster assembly of claim 2, wherein the boosting piston is provided at an outer circumferential surface thereof with a boosting force coupling part that is configured to make contact with the reaction disc.
